(19) United States
(12) Patent Application Publication
(10) Pub. No.: US 2021/0401223 A1
(43) Pub. Date: Dec. 30, 2021

(54) COOKING DEVICE HAVING CAMERA

(71) Applicant: LG ELECTRONICS INC., Seoul (KR)

(72) Inventors: Dayun HAN, Seoul (KR); Yunsik PARK, Seoul (KR); Sungmok HWANG, Seoul (KR)

(73) Assignee: LG ELECTRONICS INC., Seoul (KR)

(21) Appl. No.: 16/636,895

(22) PCT Filed: Aug. 30, 2019
(86) PCT No.: PCT/KR2019/011113

§ 371 Date: Feb. 5, 2020

(51) Int. Cl. A47J 36/32; G10L 15/22; G06N 20/00; G06T 7/90

(52) U.S. Cl. CPC A47J 36/32; G10L 15/22; G06F 3/167; G06T 7/90; G06N 20/00

(57) ABSTRACT

The present disclosure relates to a cooking device, and more particularly, to a cooking device in which a cooking target is accommodated in a cooking space to perform cooking. According to one embodiment of the present disclosure, a cooking device and its control method may be provided, wherein the cooking device comprises a cavity provided to accommodate a cooking target; a camera module configured to capture a first image of the cooking target located in the cavity; a heating module configured to heat the cooking target; an interface configured to receive an input including a cooking temperature and a cooking time; and a controller configured to: output a second image of the cooking target based on the received input, wherein the second image corresponds to a predicted image of the cooking target after cooking is finished; and control the camera module and the heating module based on the received input.

### TECHNICAL FIELD

The present disclosure relates to a cooking device, and more particularly, to a cooking device for cooking a cooking target accommodated in a cooking space.

### BACKGROUND

A cooking device means a device or home appliance for cooking a cooking target by applying heat to the cooking target. Examples of the cooking device may include a cooking device for cooking a cooking target by directly applying heat to a vessel in which the cooking target is accommodated, and a cooking device for cooking a cooking target by heating a cooking space after the cooking target is accommodated in the cooking space.

The cooking space or a cooking target accommodating space may be referred to as a cavity, and if a door is closed, an inner space of the cavity is isolated from an outer space of the cavity, and if the door is opened, the inner space of the cavity is communicated with the outer space of the cavity.

An oven which is one of the cooking device may be considered as one of home appliances in which a cooking target is cooked in the inner space of the cavity.

The oven may be divided into a light wave oven, an electromagnetic wave oven, a gas oven and an electric heater oven in accordance with a heating source, that is, a heating scheme. The oven may be more subdivided.

Since the cooking device such as oven cooks by accommodating a target in a certain space, it is difficult to check a cooking state with the naked eye. Therefore, it is difficult to check an optimal cooking state. For this reason, a transparent window may be provided in a door provided in front of the cooking device to allow a user to externally see a cooking target. However, since the transparent window is treated with a polarized film, it is not easy to check a cooking state of a target with the naked eye. Therefore, in most cases, the user repeatedly checks the cooking state of the target with the naked eye by opening the door.

A cooking time in the cooking device such as oven is relatively long. Therefore, repeated opening of the door may cause inconvenience of the user. For this reason, most of cooking devices provide recipes of cooking targets. That is, the cooking devices have cooking parameters suggested or set per recipe.

However, even though cooking is performed in accordance with a recipe which is set, most of users are likely to check a state of a cooking target by opening the door before cooking is finished.

Therefore, a cooking device that may effectively check a cooking state while minimizing door opening will be required. Also, a cooking device that may enhance cooking satisfaction using the existing cooking experiences will be required.

### SUMMARY

The present disclosure is intended to solve the aforementioned problems of the cooking device of the related art.

An object of the present disclosure is to provide a cooking device customized for a user by recognizing a cooking target through a camera.

Another object of the present disclosure is to provide a cooking device that may easily be used through a voice command. Particularly, the present disclosure is to provide a cooking device that may recognize a subjective and emotional control command and effectively reflect the control command.

Still another object of the present disclosure is to provide a cooking device that may allow a user to check a cooking target with the naked eye within a minimum range in the middle of cooking by providing a user with an image of the cooking target (cooking prediction image) predicted after cooking is finished.

Further still another object of the present disclosure is to provide a cooking device that may allow a user to more easily input manipulation or setting of a cooking parameter by changing a cooking prediction image to correspond to a change of the cooking parameter.

Further still another object of the present disclosure is to provide a cooking device having a convenient user interface by enabling an input of a cooking command or a cooking parameter through a cooking prediction image.

Further still another object of the present disclosure is to provide an advanced smart cooking device by applying artificial intelligence (AI) learning having a cooking command or a cooking parameter as an input and a cooking prediction image as an output.

Further still another object of the present disclosure is to provide a cooking device that may extend a user interface to an external terminal by enabling communication with an external server or the external terminal.

To achieve these objects and other advantages and in accordance with the purpose of the invention, according to one embodiment of the present disclosure, a cooking device and its control method may be provided, in which the cooking device comprises a cabinet; a cavity provided to accommodate a cooking target; a door rotatably provided in the cabinet, having a transparent window; a camera module provided to generate an image by capturing the cooking target accommodated in the cavity; a heating module heating and cooking the cooking target; a user interface provided to allow a user to input a cooking command or a cooking parameter that includes a cooking temperature and a cooking time; an artificial intelligence (AI) module outputting an image (cooking prediction image) of a cooking target predicted after cooking is finished by using transition of the cooking parameter from the start of cooking to a current timing as an input by means of learning; and a controller controlling driving of the camera module, the heating module and the AI module based on the cooking command or the cooking parameter.

In this case, the cooking command may be a cooking start command for a specific recipe. If the specific recipe is determined, a cooking parameter for the specific recipe may be set automatically.

The cooking parameter is a parameter for determining how to perform cooking. For example, the cooking parameter may include a cooking time or a cooking temperature. In more detail, a change of a cooking temperature according to passage of the cooking time may be the cooking parameter.

For example, a preheating temperature after cooking starts, a temperature in the middle of cooking, and a temperature at the end of cooking may be set differently.

Preferably, the cooking device further comprises a memory storing an image generated by capturing the cooking target.

Previously generated images may be stored in the memory. That is, images generated by a cooking device seller or manufacturer as well as images generated by a user while the user is directly using the cooking device may be stored in the memory. Also, images generated by other users while the other users are using the cooking device may be stored in the memory. That is, the images may be updated through a server.

Preferably, the memory classifies a plurality of images generated for the same cooking target in accordance with a cooking level based on a color change of the cooking target and then stores the images. Therefore, if there 10 images for the same cooking target, the images may be stored by being classified in accordance with a cooking level.

Preferably, if there is a specific image corresponding to the cooking prediction image in the images stored in the memory, the AI module outputs the specific image as the cooking prediction image.

If there is no specific image, the specific image may be output by being downloaded through the server. At this time, it is preferable that the respective images are stored to be matched with input factors. Also, the AI module may generate and output a new image through learning if there is no specific image.

That is, a difference of a cooking level may be checked through a color change of the cooking target. Therefore, a specific image may be generated through previous and following images of the cooking level if there is no specific image.

Preferably, the user interface is provided to display the cooking prediction image. To this end, the cooking device may be provided with a display or a touch display. The user does not check a cooking state of a cooking target with the naked eye in the middle of cooking due to the cooking prediction image. Therefore, it is very convenient to use the cooking device.

The user interface may include a microphone receiving a cooking command or a cooking parameter through a user's voice. The user may not directly select the cooking command or the cooking parameter. Therefore, it is very convenient to use the cooking device.

The cooking device may further comprise a voice recognition module classifying and recognizing an increase or decrease command of a relative cooking level based on the cooking prediction image from the user's voice received from the microphone.

The voice recognition module may be provided to recognize more subjective, emotional and relative command as well as a direct cooking parameter setting command such as cooking temperature increase or decrease or cooking time increase or decrease.

For example, the voice recognition module may recognize a voice command such as “rare”, “well-done” and “medium” as a command indicating a relative increase or decrease of a cooking level. That is, the voice recognition module may recognize and reflect such a command from a cooking level predicted through a current cooking command or cooking parameter. Therefore, the voice recognition module may change and set the cooking parameter to be suitable for increase or decrease from a cooking level which is currently predicted.

The voice recognition module may recognize a difference in an increase or decrease level of a cooking level through a voice command. That is, the voice recognition module may recognize a difference in a cooking level of a command such as “well-done” and a command “very well-done”. Therefore, a change width of the cooking parameter may be more increased.

The controller may reset a current cooking parameter based on the increase or decrease command of the relative cooking level recognized by the voice recognition module.

Preferably, if the cooking command or the cooking parameter is changed, the user interface displays the changed cooking prediction image. Therefore, the user may intuitively check how the cooking level is changed based on the reset cooking command or cooking parameter. Therefore, it is convenient to use the cooking device.

Preferably, the user interface provides the changed cooking time to correspond to the changed cooking prediction image.

Any one of the images stored in the memory is selected by a user and therefore the cooking command or the cooking parameter may be input to the cooking device. Therefore, the user may input a cooking command or a cooking parameter by viewing a cooking complete image without directly selecting the cooking command or the cooking parameter through various input means (for example, button or rotary knob) If the user selects the cooking complete image, a cooking command or a cooking parameter corresponding to such an image may be set. Therefore, the user may not need to determine and select the cooking command or the cooking parameter in a complicated manner.

The cooking device may further comprise a communication module for transmitting the cooking prediction image to an external terminal. Therefore, the cooking device may extend the user interface to the external terminal.

Generally, a display, especially a display for implementing a color image or video is not built in most of cooking devices. On the other hand, it is general that a touch display having high resolution is built in the external terminal, for example, even in case of a smart phone. Therefore, the user may use the external terminal like the user interface of the cooking device. In other words, the user interface of the cooking device may be extended to the external terminal.

The user may easily check a current state of the cooking device through various kinds of cooking information (cooking command, cooking parameter, cooking prediction image, cooking residual time, information as to whether cooking is performed, etc.) provided from the cooking device. Also, the user may easily perform the cooking command or a reset command of the cooking parameter. Particularly, the user may more easily reset the cooking command or the cooking parameter by using the cooking prediction image.

To this end, it is preferable that the cooking device further comprises a communication module. The cooking device may receive a change of the cooking command or the cooking parameter from the external terminal through the communication module.

The cooking device may perform communication with the external terminal through an external server. Of course, the cooking device may directly perform communication with the external terminal.

The cooking device may further comprise a communication module for delivering a learning result of the AI module to the external server.

The cooking device may further comprise a communication module for updating a previous learning result from the external server.

The camera module may detachably be provided outside a transparent window to enable communication with the controller, or may be provided inside the transparent window.

The camera module may generate an image by capturing the cooking target to recognize the cooking target prior to cooking.

If there is a cooking history for a conventional cooking target corresponding to the above cooking target, cooking prediction images may previously be stored. Therefore, the cooking prediction images which are previously stored may be provided to a user. The user may replace an input of the cooking command or the cooking parameter by selecting a specific cooking prediction image. This is because that the specific cooking prediction image is matched with a setting value of a specific cooking parameter or a specific cooking command.

The user interface may include a speaker providing a voice for guiding a cooking mode to a user based on the recognized cooking target.

Preferably, the user interface may be displayed to guide a cooking mode to a user based on the recognized cooking target. If the user interface may not be displayed, cooking mode information may be transmitted to the external terminal and therefore the cooking mode may be guided in the external terminal.

A communication module may be provided to perform communication with an external server, and may transmit cooking information to an external terminal through the external server and receive a cooking command from the external terminal through the external server.

The aforementioned features of the embodiments may be implemented in other embodiments in combination unless contradicted or exclusive.

According to one embodiment of the present disclosure, a cooking device customized for a user by recognizing a cooking target through a camera may be provided.

According to one embodiment of the present disclosure, a cooking device, which may easily be used through a voice command, may be provided. Particularly, a cooking device, which may recognize a subjective and emotional control command and effectively reflect the control command, may be provided.

According to one embodiment of the present disclosure, a cooking device, which may allow a user to check a cooking target with the naked eye within a minimum range in the middle of cooking by providing a user with an image (cooking prediction image) of the cooking target predicted after cooking is finished, may be provided.

According to one embodiment of the present disclosure, a cooking device, which may allow a user to more easily input manipulation or setting of a cooking parameter by changing a cooking prediction image to correspond to a change of the cooking parameter, may be provided.

According to one embodiment of the present disclosure, a cooking device having a convenient user interface by enabling a cooking command or a cooking parameter input through a cooking prediction image may be provided.

According to one embodiment of the present disclosure, an advanced smart cooking device by applying AI learning having a cooking command or a cooking parameter as an input and a cooking prediction image as an output may be provided.

According to one embodiment of the present disclosure, a cooking device, which may extend a user interface to an external terminal by enabling communication with an external server or the external terminal, may be provided.

### BRIEF DESCRIPTION OF THE DRAWINGS

FIG. 1 illustrates an external appearance of a cooking device according to one embodiment of the present disclosure.

FIG. 2 illustrates that a door of a cooking device shown in FIG. 1 in greater detail.

FIG. 3 illustrates a control configuration of a cooking device according to one embodiment of the present disclosure.

FIG. 4 illustrates a control flow of a cooking device according to one embodiment of the present disclosure.

FIG. 5 illustrates an example of a cooking prediction image in a rare or underdone state of a cooking level is displayed in a user interface and/or an external terminal of a cooking device.

FIG. 6 illustrates an example of a cooking prediction image in a medium or done state of a cooking level is displayed in a user interface and/or an external terminal of a cooking device.

FIG. 7 illustrates an example of a cooking prediction image in a well-done state of a cooking level is displayed in a user interface and/or an external terminal of a cooking device.

### DETAILED DISCLOSURE

Hereinafter, a cooking device according to one embodiment of the present disclosure will be described with reference to the accompanying drawings.

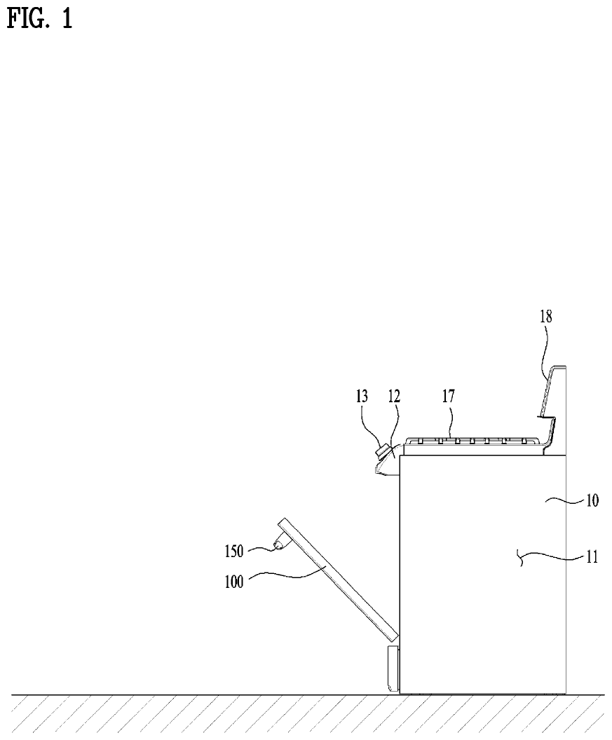

FIG. 1 illustrates a cooking device that may be applied to according to one embodiment of the present disclosure. In detail, a cooking device provided with a handle 150 on an upper surface in front of a door 100 and opened or closed while being rotated around a rotation center below the door.

The cooking device includes a cabinet 10 forming an external appearance, and a cavity 11 where cooking is performed is arranged inside the cabinet 10. This cavity may be referred to as a target accommodating unit. Likewise, the door 100 is rotatably provided in the cabinet 10, and the target accommodating unit 11 may be seen through the door 100. That is, a cooking state of the cooking target in the cavity may be checked.

A control panel 12 for user's manipulation may be provided in the cooking device, and may include a manipulation unit 13. An example of the manipulation unit may include a knob. The control panel may be provided with a selection means such as a button as well as a selection means such as a rotary knob. Also, a display for displaying a cooking time or a cooking state may be provided.

Therefore, the control panel 12 may be referred to as a user interface.

The cooking device may be provided with a cooktop 17, which forms a separate cooking area, at an upper portion of the cabinet 10. A rear display 18 may be provided if necessary. In this case, the rear display 18 may be a portion of the user interface.

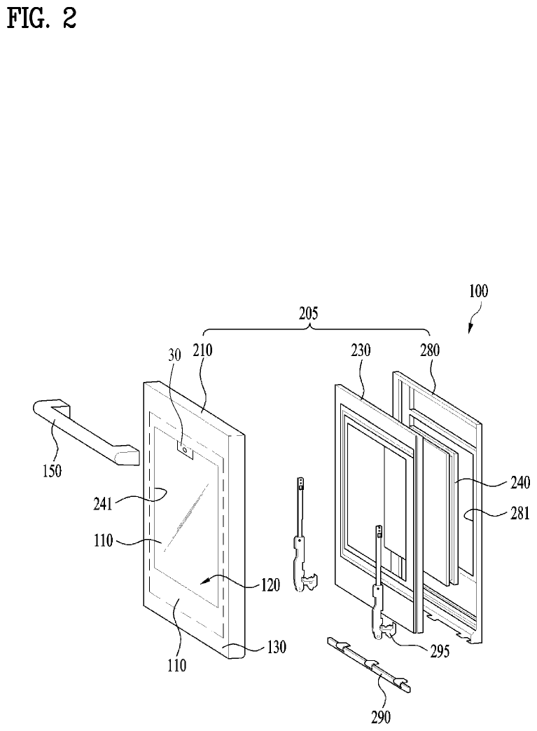

Hereinafter, a door structure of the cooking device shown in FIG. 1 will be described in detail with reference to FIG. 2. Preferably, the door structure has a structure tolerable at a high temperature because the inside (cooking space) of the cavity is a high temperature and stability from the high temperature may be given to a camera module.

The door 100 is connected with the cabinet 10 and provided to open or close the target accommodating unit 11 where a target is accommodated. The door 100 is provided with the handle 150 such that a user opens or closes the door 100 by gripping the handle 150.

The door 100 may include a plurality of frames. These frames may be combined with one another to form a door frame 205.

The door frame 205 may include an outer door 210 constituting a front surface of the door and a door liner 280 constituting a rear surface of the door. A predetermined space may be formed between the outer door 210 and the door liner 280.

An inner frame 230 may be provided between the outer door 210 and the door liner 280. Hollow portions 214, 231 and 281 may respectively be formed at the center of the frames 210, 230 and 280 to allow a user to see the target accommodating unit. The hollow portions form transparent windows 120. An insulation panel 240 and a front panel 110 corresponding to these windows may be provided.

The outer door 210 may be provided with the front panel 110. The front panel 110 may be coupled to the outer door 210 at the front of the outer door 210. However, it is preferable that the front panel 110 is coupled to the outer door 210 at the rear of the outer door 210.

The front panel 110 may be formed to be greater than the hollow portion 241 of the outer door 210. That is, the front panel 110 may be formed to completely shield the hollow portion. The front panel 110 may be formed of a glass material. The front panel 110 forms the front surface of the door 100 together with the outer door 210.

The front panel 110 may be an element to which a camera is fixed, while forming a transparent window. Therefore, a camera module 30 may be provided to be tightly fixed to the front panel 110.

The camera module 30 may tightly be fixed to the front panel 110 at the rear of the front panel 110. Of course, the camera module 30 may tightly be fixed to the front panel 110 at the front of the front panel 110. In any case, the camera module may be fixed to a position where the inside of the cavity may be captured through the transparent window.

The camera module 30 may detachably be provided in the door through a magnet or a separate bracket. In this case, the camera module may be provided to perform communication with a controller 100. The camera module may generate an image under the control of the controller and transmit the generated image to the cooking device.

A window panel 240 may be provided together with the front panel 110. Since the window panel 240 is provided for insulation, the window panel 240 may be referred to as an insulation panel. This insulation panel may be formed of multiple layers, and is preferably formed of a glass material.

A hinge 295 through which the door 100 is opened or closed may be provided inside the door 100. The home appliance may be a pull-down type door. Therefore, the hinge 295 may include a damper.

A shielding panel 290 may be formed below the door 100.

Meanwhile, unlike FIG. 2, the camera module 30 may be provided inside the door. The camera module may be buried in the door and fixed between the front panel and the insulation panel or between the insulation panels to allow heat to be directly transferred thereto.

The transparent window 120 may fully be treated with a polarizing film. However, image resolution may be deteriorated or it may be difficult to generate a definite image due to the treatment of the polarizing film.

Therefore, the treatment of the polarizing film may be excluded or minimized in the portion of the transparent window corresponding to the camera module.

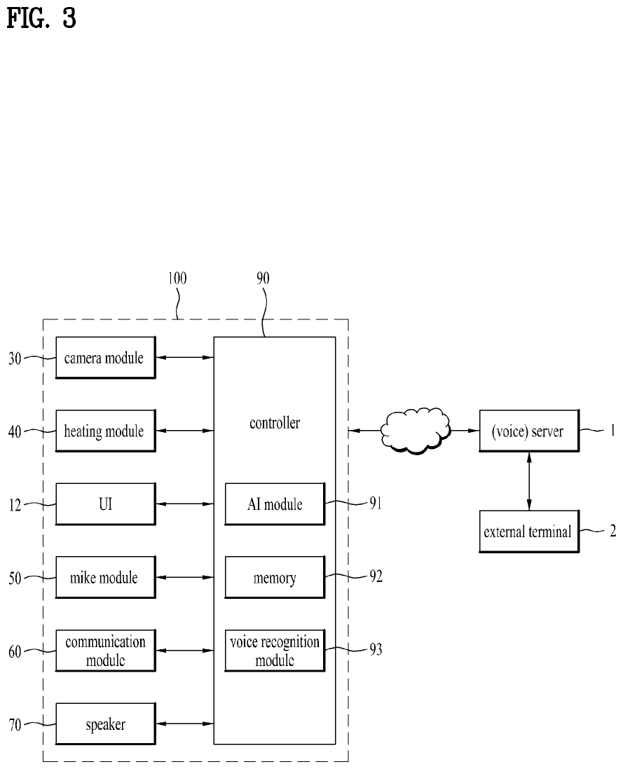

Hereinafter, a control configuration of the cooking device according to one embodiment of the present disclosure will be described in detail with reference to FIG. 3.

The camera module 30 is provided to generate an image by capturing a cooking target. The camera module 30 is provided to capture a cooking target accommodated in the cavity.

A condition inside the cavity may be considered as a very high temperature state. Therefore, it is required to protect the camera module from the high temperature. To this end, the camera module 30 may be provided at the front of the door. That is, the camera module 30 may be provided between on an outer surface of the door not an inner surface which is directly in contact with the cavity, or may be provided between the inner surface and the outer surface of the door.

Also, the camera module 30 may be provided detachably. The camera module may be fixed to or removed from the front surface of the door if necessary. In this case, the camera module may be provided to be connected with a controller 90 by communication.

A heating module 40 is provided to cook a cooking target through heating. The heating module 40 may be a module for heating the target like a gas heater or an electric heater, or may be a module for cooking the target by using microwaves. The controller 90 controls an operation time, an operation timing and operation conditions (temperature and output) of the heating module.

The user interface (UI) may be provided to allow a user to input a cooking condition and check a cooking state. The UI may include a display, and may display one or more of various images such as an image generated through the camera module, an image downloaded through a server and an image stored in a memory 92. The UI may display an image currently captured or an image captured in the past.

In detail, the UI may display an image currently captured and an image predicted after cooking is finished. Therefore, the user may intuitively check a current cooking level through the currently captured image and the predicted image.

A microphone 50 may be provided to recognize a voice command of a user. Therefore, the microphone 50 may be considered as a portion of the UI. Since a voice command may be performed through the microphone, the user may easily a control command even without manipulation such as a button or a rotary knob.

A speaker 70 may be provided to output a current state or an alarm in the cooking device as voice. Therefore, the speaker 70 may be considered as a portion of the UI. The speaker 70 of the cooking device may output a confirmation message for a voice command of the user as voice. That is, a voice output for confirming a voice command or a voice output for performing the received voice command may be performed through the speaker.

The controller 90 controls the operation of the cooking device based on a command of a user, which is input through the UI or the microphone 50.

The controller 90 may include an artificial intelligence (AI) module 91. The AI module 91 may be provided separately from the controller to perform wired and wireless communication with the controller. The controller may control the operation of the cooking device based on the output of the AI module. AI module is a module 91 equipped with advanced computer programs based on human intelligence, which uses a logical way of thinking, thinking, learning, and judging like a human being in a computer. In some implementations, the AI module 91 may correspond to one or more processors. In other implementations, the AI module 91 may correspond to software components configured to be executed by one or more processors.

The controller 90 may include a memory 92. The memory 92 may be provided separately from the controller to perform wired and wireless communication with the controller.

The controller may include a voice recognition module 93. The voice recognition module 93 may be provided separately from the controller to perform wired and wireless communication with the controller. The voice command of the user, which is received through the microphone 50, may be recognized and analyzed by the voice recognition module. The voice recognition module 93 is a module in which a computer converts an acoustic speech signal obtained through a sound sensor such as a microphone into words or sentences.

The cooking device 100 may be connected with an external server 1 by communication. To this end, the cooking device may include a communication module 60. As the cooking device is connected with the external server by communication, the cooking device may transfer the image generated through the camera module and its related information to the external server.

For example, the image generated after cooking is finished may be matched with information related to a cooking history. That is, it is possible to check a cooking process of a cooking target. For example, information such as a kind of a cooking target, a cook name, a cooking course, a cooking temperature and time condition may be matched with a cooking image. An image at a start step of cooking or an image in the middle of cooking as well as the image generated after cooking is finished may be generated, and may be matched with its related information. Therefore, as cooking experiences are accumulated through the cooking device 100, image and related information may be accumulated.

Also, the cooking device 100 may download an image and related information through a server. That is, the cooking device 100 may easily receive cooking experiences of another cooking device, which are accumulated in the server.

Therefore, the user may use the cooking device very effectively by easily receiving cooking experiences and information of other users through the same cooking device.

Meanwhile, the server 1 may be a server that provides voice recognition. In this case, the voice recognition module does not need to be fixed to the cooking device. That is, the voice command received through the microphone 50 of the cooking device may be transferred to the server 1, and the server may recognize and analyze the voice command.

Therefore, since the cooking device does not need a complicated and expensive module for voice recognition and analysis, the cooking device is able to be cost effective, wherein user satisfaction may be enhanced.

The user may use various remote services such as remote control or monitoring of the cooking device through the external terminal 2. That is, the external terminal 2 interworking with the cooking device may be connected with the cooking device by communication through the server.

An application associated with the cooking device is installed in the external terminal, and the user may use various remote services by executing the application. Generally, the external terminal has a display of high picture quality. Also, the external terminal has a speaker and a microphone. Therefore, the speaker, the microphone and the display of the external terminal may enable extension of the UI of the cooking device.

In other words, a voice command for the cooking device, a display of a cooking target image, and a confirmation voice output or cooking execution voice output for a cooking command may be implemented through the external terminal.

The user may use various remote services such as a cooking state, a cooking condition, a cooking prediction time, a cooking prediction image, a cooking command, and a cooking condition change through the external terminal in a state that the user is far away from the cooking device. For example, the user may input a cooking command with his/her voice through the external terminal. Also, the user may input cooking parameters including a cooking temperature and a cooking time with his/her voice through the external terminal. Therefore, the UI of the cooking device may be extended to the external terminal.

If the cooking command or the cooking parameter is received through the external terminal, the controller controls the operation of the cooking device based on the received cooking command or cooking parameter. That is, the controller may control driving of the camera mode, the heating module and the AI module.

Meanwhile, the AI module may output an image (cooking prediction image) of a cooking target predicted after cooking is finished by using the cooking command or the cooking parameter received through the UI of the cooking device or the external terminal as an input. The cooking prediction image may be any one of images generated by the camera module and then stored in the memory, or may be any one of images updated through the server.

The cooking prediction image that may optimally be matched with a current cooking command or a cooking parameter may be output, whereby the user may determine whether his/her input of the cooking command or the cooking parameter is optimal.

In another aspect, the user may input the cooking command or the cooking parameter through the cooking prediction image. That is, the cooking prediction image is matched with information such as the cooking command or the cooking parameter. Therefore, selection of a specific cooking prediction image may be the same as selection of information such as a specific cooking command or cooking parameter.

For example, if an image of a cooking target which is well-done is selected, it may be considered that information on a cooking history is selected. Therefore, the user may easily select a cooking command or a cooking parameter by excluding selection of a complicated and inconvenient cooking command or cooking parameter. That is, the user may perform these processes at one time by selecting only one image.

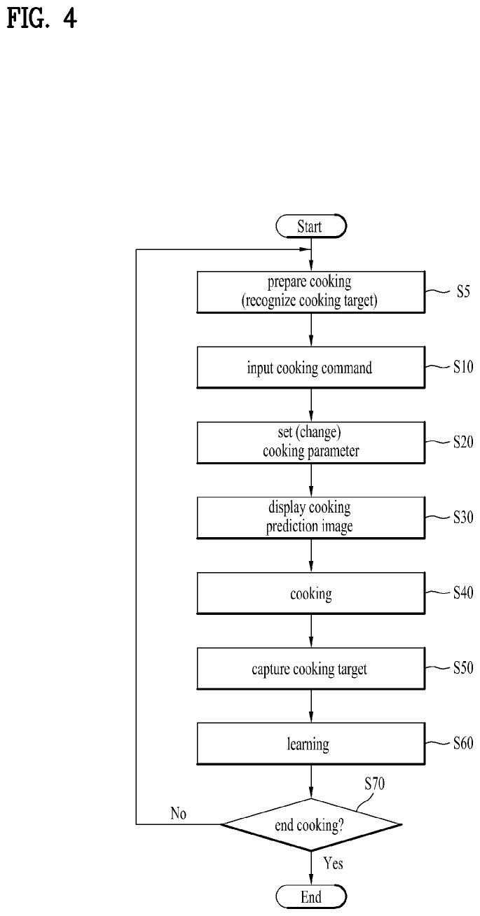

Hereinafter, a method for controlling a cooking device according to one embodiment of the present disclosure will be described in detail with reference to FIG. 4.

The user may perform an input step (S10) of a cooking command or a setting step (S20) of a cooking parameter through the UI, the microphone or the external terminal. The setting step of the cooking parameter may be intended to change the cooking parameter set by the cooking command.

A step S5 of recognizing the cooking target may be performed before, in the middle of, and after the setting step S20 of the cooking parameter. Recognition of the cooking target may be performed in such a manner that the camera module generates an image by capturing the cooking target. Recognition of the cooking target may be performed in the process of preparing cooking. The process of preparing cooking may be considered as the process of inserting the cooking target into the cooking device by means of the user. Also, the process of preparing cooking may include applying a power source of the cooking device.

If the cooking command the cooking parameter are set, the cooking prediction image may be displayed (S30). As the cooking prediction image, a specific cooking prediction image may be displayed in accordance with a current cooking command and a cooking parameter. The result of previous learning may be displayed, and the image stored in the memory may be displayed. Preferably, the cooking prediction image is an image corresponding to the recognized cooking target.

For example, if a user cooks “grilled chicken”, a chicken image prior to cooking may be generated, whereby the cooking target may be recognized. In this case, it is preferable that a cooking prediction image corresponding to “grilled chicken” is selected and displayed. A cooking level may be checked through the cooking prediction image, and may be varied depending on a previously input cooking command and cooking parameter.

Therefore, the user may predict the cooking level through the cooking prediction image. For example, if the user wants a well-done cook, the user may change the cooking parameter. At this time, the user may provide a command “cook it more” through his/her voice. The cooking device may increase a cooking time by recognizing this voice command and/or vary a cooking level by increasing the cooking temperature.

Meanwhile, if selection of the user ends, cooking (S40) may be performed. As cooking is performed, capturing (S50) of the cooking target may be performed repeatedly or periodically. Cooking history information (cooking command or cooking parameter, change transition of the cooking parameter, etc.) up to a capturing time may be acquired. Therefore, a generated image and this related information may be matched with each other and stored.

That is, the cooking prediction image may be devised through learning by using a cooking condition as an input. This learning result may be used for the aforementioned display (S30) of the cooking prediction image. For example, a cooking prediction image most similar to the current cooking condition may be output from images of the same cooking target and then displayed.

For example, the cooking prediction image which is displayed may be changed. This may be a request of the user. In other words, if the user changes the cooking condition in the middle of cooking, the cooking prediction image corresponding to the changed cooking condition may be displayed. A cooking prediction image more suitable for the current cooking condition may be displayed in the middle of cooking.

Meanwhile, the user may select a specific cooking prediction image after recognizing a cooking target. For example, a plurality of corresponding cooking prediction images may be displayed after the cooking target is recognized. The cooking prediction images may be displayed in due order, and the user may select any one of the cooking prediction images by manipulating a scroll or button.

Selection of a specific cooking prediction image may be considered as selection of a cooking condition. This is because that the cooking condition is matched with the specific cooking prediction image. Therefore, as the specific cooking prediction image is selected, processes such as selection of a cooking command and setting of a cooking parameter may be simplified. That is, the user does not need to recognize and select a detailed and complicated condition such as a cooking time or a cooking temperature.

If the user selects a specific cooking prediction image, a corresponding cooking condition may be displayed, and especially a predicted cooking time may be displayed.

The user determines whether cooking ends in such a way of determining whether a cooking set time passes or cooking ends forcibly (S70). If cooking does not end, the aforementioned steps may be repeated. If a cooking end condition is satisfied, cooking may end.

Meanwhile, the cooking prediction images may be stored separately depending on a cooking level. That is, the cooking targets may be stored by being classified into rare, medium and well-done. This may be intended to effectively correspond to an emotional user's voice command.

The cooking level may be classified based on a color difference or change of the cooking targets.

If there is a specific image corresponding to the cooking prediction image in the images stored in the memory, the AI module may output the specific image as a cooking prediction image. For example, if there are ten cooking prediction images in accordance with a cooking level, a cooking prediction image having a seventh cooking level may be output for a voice command “cook it well-done”. Afterwards, if the user provides a voice command “cook it more”, a cooking prediction image having an eighth cooking level may be output. If the user continues to enhance a cooking level, a cooking prediction image having a tenth cooking level may finally be output. If the user wants a higher cooking level, a cooking prediction image corresponding to the higher cooking level is not output. Therefore, the image generated after cooking is finished may be used as a new cooking prediction image having an eleventh cooking level.

According to this embodiment, the user may perform an increase or decrease command of a relative cooking level based on the cooking prediction image through the microphone. The controller or the voice recognition module may identify and recognize the increase or decrease command of the relative cooking level. A cooking prediction image changed in response to this command may be displayed. The cooking prediction image may be displayed through the cooking device or the external terminal. Therefore, the cooking device which may be used intuitively and easily may be provided.

Therefore, according to this embodiment, the cooking prediction image may be extended and diversified. That is, an evolved cooking prediction image may be provided based on the user's experiences. Therefore, a customized cooking device may be provided, and a smart and convenient cooking device may be provided.

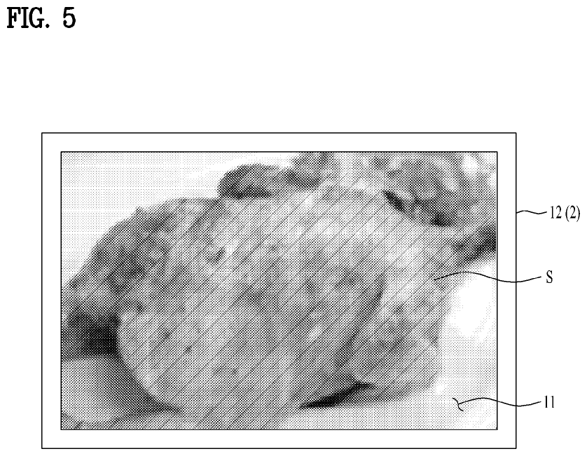

Hereinafter, embodiments for cooking prediction images will be described in detail with reference to FIGS. 5 to 7.

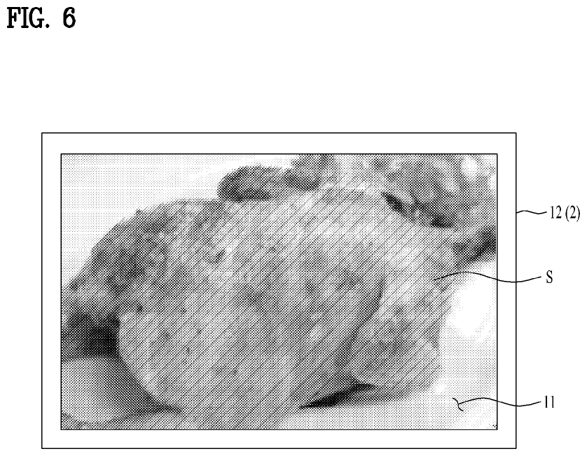

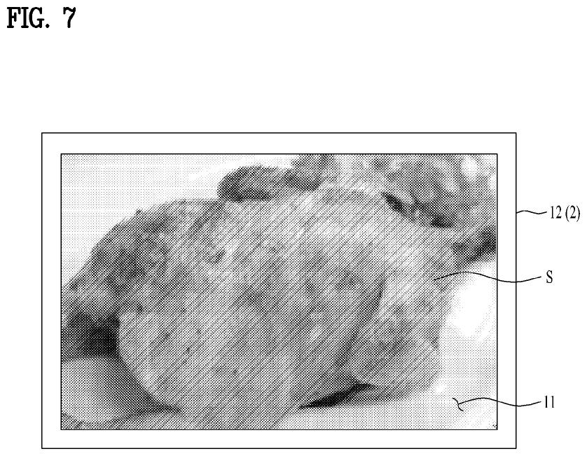

Cooking prediction images for the same cooking target are shown in FIGS. 5 to 7. An example of a cooking prediction image corresponding to “rare” is shown in FIG. 5, an example of a cooking prediction image corresponding to “medium” is shown in FIG. 6, and an example of a cooking prediction image corresponding to “well-done” is shown in FIG. 7.

The cooking level may be checked through a color change of the cooking target. The color change of the cooking target may be diversified depending on the cooking target. For example, the cooking level may be higher for a darker red or darker brown.

The image shown in FIG. 6 is the cooking prediction image, and may be displayed. The user may replace setting of a cooking command and a cooking parameter by selecting the image.

If the user wants to cook food more before cooking or in the middle of cooking, the user may perform a change of the cooking parameter. If the user commands “cook it more” through his/her voice command, the cooking prediction image may be displayed by being changed to the image shown in FIG. 7.

If the cooking device checks the change of the command through a voice or display, the user may provide a command for granting the change of the command through the UI or voice.

The controller changes and sets the cooking parameter as matched with the changed cooking prediction mage, and performs cooking based on the changed cooking parameter.

Meanwhile, the cooking prediction image may be displayed or the cooking command may be provided (changed) through the external terminal.

The user may remotely control or monitor the cooking device at a position spaced apart from the cooking device through the external terminal. That is, the external terminal may perform communication with the server, and the server may perform communication with the cooking device, whereby these steps may be performed.

Therefore, the user may easily use the cooking device even without directly manipulating the cooking device or approaching the cooking device.

### INDUSTRIAL APPLICABILITY

Industrial applicability is described in the present disclosure.

1-20. (canceled)

21. A cooking device comprising:
a cavity provided to accommodate a cooking target;
a camera module configured to capture a first image of the cooking target located in the cavity;
a heating module configured to heat the cooking target;
an interface configured to receive an input including a cooking temperature and a cooking time;
an artificial intelligence (AI) module configured to output a second image of the cooking target based on the received input, wherein the second image corresponds to a predicted image of the cooking target after cooking is finished; and
a controller configured to control the camera module, the heating module, and the AI module based on the received input.

22. The cooking device of claim 21, further comprising a memory configured to store the captured first image of the cooking target.

23. The cooking device of claim 22, wherein the controller is further configured to:
classify a plurality of images of a same cooking target based on a respective cooking level according to a color change of the cooking target; and
store the plurality of images in the memory.

24. The cooking device of claim 21, wherein the AI module is further configured to output a specific image from a plurality of images stored in a memory as the second image, wherein the specific image is selected for outputting based on a determination that the specific image is associated with a same cooking level as the received input.

25. The cooking device of claim 21, wherein the interface is further configured to display the second image.

26. The cooking device of claim 25, further comprising a microphone configured to receive the input via a voice of a user.

27. The cooking device of claim 26, wherein the input is recognized as a command to increase or decrease a cooking level from the voice of the user received via the microphone.

28. The cooking device of claim 27, wherein the controller is further configured to reset a current cooking parameter based on the recognized command.

29. The cooking device of claim 25, wherein the interface is further configured to display a modified image of the second image when a cooking command or a cooking parameter is changed.

30. The cooking device of claim 29, wherein the interface is further configured to display a changed cooking time corresponding to the modified image of the second image.

31. The cooking device of claim 25, wherein the received input corresponds to a selection of one of a plurality of images displayed via the interface.

32. The cooking device of claim 21, further comprising a communication module configured to transmit the second image to an external terminal.

33. The cooking device of claim 32, wherein a change of a cooking command or a cooking parameter is received from the external terminal via the communication module.

34. The cooking device of claim 21, further comprising a communication module configured to deliver a training result of the AI module to an external server.

35. The cooking device of claim 21, further comprising a communication module configured to update a previous training result from an external server.

36. The cooking device of claim 21, wherein the camera module is detachably provided outside a transparent window or is provided inside the transparent window, wherein the transparent window is part of the cooking device.

37. The cooking device of claim 21, wherein the controller is further configured to recognize the cooking target prior to cooking based on the captured first image.

38. The cooking device of claim 37, wherein the interface is further configured to include a speaker configured to output audio for guiding a cooking mode to a user based on the recognized cooking target.

39. The cooking device of claim 37, wherein the interface is further configured to display a cooking mode based on the recognized cooking target.

40. The cooking device of claim 21, further comprising a communication module configured to transcieve data with an external server,
wherein the communication module is further configured to transmit cooking information to an external terminal via the external server and receive a cooking command from the external terminal via the external server.
